(19) United States
(12) Patent Application Publication
(10) Pub. No.: US 2007/0084174 A1
(43) Pub. Date: Apr. 19, 2007

(54) Fogging system capable of killing insects for use with a lawn mower

(76) Inventor: Sandra E. Weiland, Troy, MO (US)

Correspondence Address: SUNG I. OH, PROFESSIONAL LAW CORPORATION, 710 QUAIL VALLEY LANE, WEST COVINA, CA, 91791, US

(21) Appl. No.: 11/254,254

(22) Filed: Oct. 19, 2005

(51) Int. Cl. A01D 19/00

(52) U.S. Cl. 56/16.8

(57) ABSTRACT

A lawn mower having an internal combustion engine has a container of liquid insectide or other chemical that can be spread on vegetation during a mowing process hung on a crossbar of the mower. The container is fluidically connected to a muffler associated with the mower and chemical from the container is fed into the muffler to be mixed with hot exhaust gases flowing through the muffler from the engine. The chemical is vaporized, mixed with the hot exhaust gases and then dispersed as the gases are exhausted from the muffler.

### BACKGROUND OF THE INVENTION

1. Field of the Invention:

The present invention relates to the general art of machines for lawn treatment, and to the particular field of lawn mowers.

2. Related Art:

Commercial lawn maintenance is a labor intensive task. Beside the frequent mowing of the lawn to the desired height, proper lawn maintenance additionally includes the steps of applying fertilizer, where the fertilizer is mainly available as solid, granular material, and of spraying liquid weed killers, insecticides and the like over the lawn.

It has been the practice for the home owner to use a lawn mower for cutting the grass and then use a separate machine or hand distribution device for spraying the lawn with weed killer or the like. Such use of multiple, single-purpose machines is economically wasteful. It is not prudent to tie up investment in many special-purpose machines, some of which will be used only a few times out of a year.

The step of mowing the lawn has been greatly facilitated by the introduction of riding lawn mowers. But there still remain three different lawn care operations to be carried out, i.e., mowing the lawn, applying solid granular fertilizer to the lawn, and spraying liquid weed killers or insecticides over the lawn. Conventionally, these three operations were carried out independently, one after the other, which is not only time consuming, but also requires three different machines. It is expensive to acquire and maintain the machines, burdensome to transport multiple machines, and costly to separately store the machines. Some attempts have been made to combine at least some of these functions in a single machine. However, such combinations mainly have occurred in connection with manually operated walk-behind machines.

Numerous attempts have been made to solve the economics of lawn spraying by mowing and spraying at one and the same time. The prior art has dealt principally with the formulation of dual-purpose machines which by and large are just as uneconomical as the multiple single-purpose machines for the same work to be done. What has been needed in the industry is a new concept that would bring the cost of the lawn spray device in line with its low level of annual utilization.

To be most useful, any accessory for a lawnmower must be easy to install. This will allow an existing mower to be retrofit with the accessory and will allow a factory to include the accessory without increasing the significantly cost of the mower. Furthermore, once installed, the accessory must be easy to use; otherwise, a user may not want the accessory.

### INVENTION SUMMARY

The present invention is generally directed to an arrangement for generating an insecticide fog in connection with the operation of a lawn mower. Many of the objectionable insects, such as mosquitoes, will be destroyed during the lawn mowing operation by having the internal combustion engine of the mower used to produce an insecticide fog. The device embodying the present invention includes a container of insecticide that is conveniently coupled to a crossbar of the lawnmower in a location that is easily accessible by an operator. The container is fluidically connected to the muffler of the internal combustion engine associated with the lawn mower. The fluid connection between the container and the muffler allows the insecticide to flow at a controlled rate into the hot muffler to be vaporized by hot exhaust gases passing through the muffler from the engine. The insecticide is of the type that vaporizes upon contact with gases of the temperature commonly found in exhaust gases associated with lawn mower engines. Kerosene can also be used for the insecticide if desired. Upon the solution contacting the hot exhaust gases in the muffler, the solution is volatilized and mixed with the gases and is then blown out through the muffler in a fog which will travel for a substantial distance and settle over the adjoining vegetation.

It is noted that while the present disclosure refers to insecticide, the system embodying the present invention can also be used in conjunction with fertilizers, weed killers, or any other chemical that might be dispersed onto a lawn. Accordingly, even though the disclosure refers to insecticides, such reference is not intended to be limiting but only an example.

The device embodying this invention satisfies low cost requirements dictated by low level utilization by being an attachment to and powered by an existing piece of equipment already available—notably the gas-engine powered lawn mower.

The device embodying this invention will save the home lawn and garden expert valuable time. A device that dispenses liquid fertilizer, pesticide or fungicide over the lawn at the same time grass is being mowed saves the operator the burden of re-traversing the lawn a second time.

The device embodying the present invention represents an improvement over the prior art in that it applies the fertilizer, pesticide or fungicide in a manner most suited to the needs of modem lawn care and maintenance. Furthermore, because the liquid storage tank is simply hung or attached to a handle area of the lawmnower, the tank is easily serviced, filled and re-filled, mounted and re-mounted whereby the accessory is easy to install and use. Direct mixing of the insecticide and hot exhaust gases also improves the efficiency of the mixing, vaporization and dispersing process.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows a power lawnmower embodying the present invention.

FIG. 2 is a perspective view of the insecticide dispersing accessory used on a power lawnmower.

FIG. 3 is an elevational view taken along line 3-3 of FIG. 2.

FIG. 4 is a detail view of an injection nozzle that is mounted on a muffler of the power lawnmower in the system embodying the present invention.

FIG. 5 shows the injection nozzle mounted on a muffler in the system embodying the present invention.

FIG. 6 shows the injection nozzle mounted on a muffler in a different orientation compared to FIG. 5.

### DETAILED DESCRIPTION OF THE INVENTION

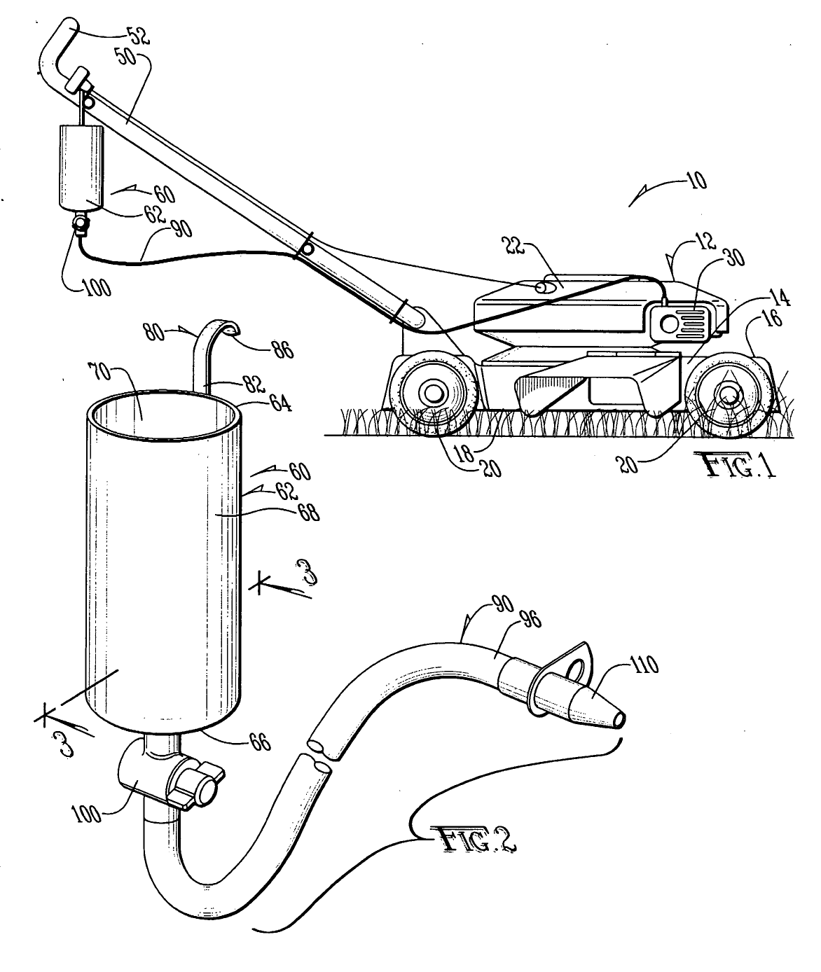

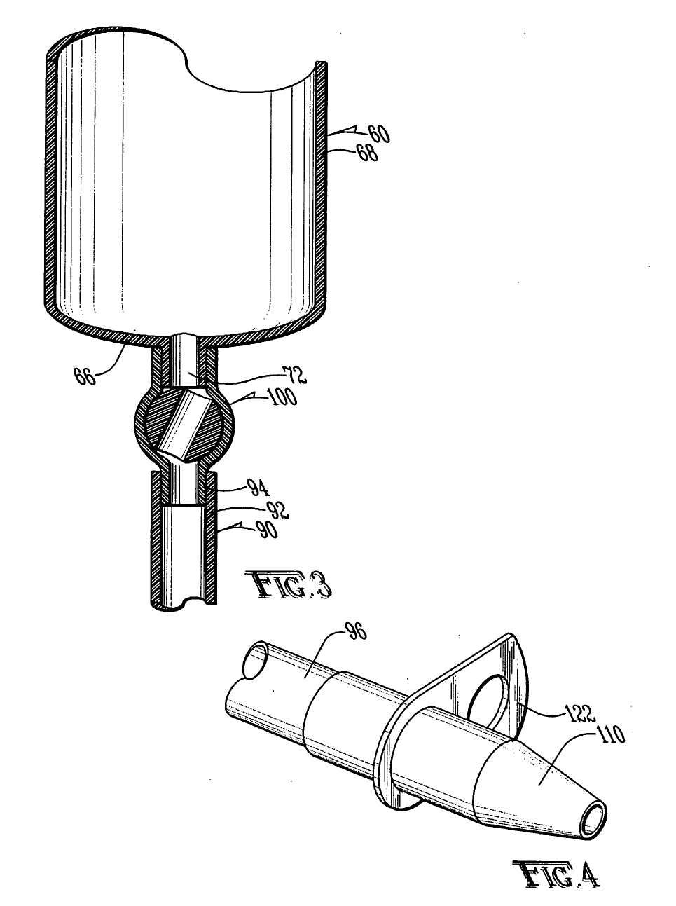

FIG. 1 shows a system 10 including a lawnmower 12 that has a housing 14 which has a first surface 16 that is a top surface when lawnmower 12 is in use and a second surface 18 that is a bottom surface when the lawnmower is in use. Wheels 20 are mounted on the bottom surface of the housing, and an internal combustion engine 22 is mounted on the top surface of the housing. The internal combustion engine may be operatively connected to the wheels to drive the wheels and propel the lawnmower when the lawnmower is in use. Internal combustion engine 22 includes a muffler 30 that is fluidically coupled thereto to receive hot exhaust gases being generated by the internal combustion engine during operation and to direct those hot exhaust gases out of the internal combustion engine into the area surrounding the lawnmower when the lawnmower is in operation.

Muffler 30 includes a housing 32, an inlet end 34, an outlet end 36, and an internal area 38 in which exhaust gases from the internal combustion engine are located as the gases flow in direction 40 from the internal combustion engine into the area surrounding the lawnmower during operation of the internal combustion engine. A handle 50 is contacted by a user when the lawnmower is in use. A crossbar 52 is mounted on the handle where it is conveniently reached by a user.

A chemical dispersing system 60 is attached to the lawnmower and includes a container 62 which includes a first end 64 which is a top end when the container is in use, a second end 66 which is a bottom end when the container is in use, and a wall 68 which connects the first end of the container to the second end of the container. An internal volume 70 is defined by second end 66 and wall 68. A fluid outlet port 72 is defined in second end 66 of the container.

A J-shaped hanger 80 has a first end 82 may be mounted on wall 68 of the container adjacent to top end 64 thereof, and a second end 86. Hanger 80 may be arcuate adjacent to second end 86 thereof and is mounted on crossbar 52 of the lawnmower by the arcuate portion thereof when the container is in use. Thus, the hanger connects the container to the lawnmower in a location that is convenient for use by the user.

A flexible conduit 90 has an inlet end 92 mounted on the second end of the container as by a nipple 94 or the like, adjacent to fluid outlet port 72 and is fluidically connected to internal volume 70 of the container via fluid outlet port 72. Flexible conduit 90 also has an outlet end 96. A fluid flow control valve 100 is mounted on the flexible conduit closely adjacent to inlet end 92 of the. flexible conduit and connected thereto to control the flow of fluid in the. flexible conduit. A drip nozzle 110 is located on outlet end 96 of the flexible conduit. Drip nozzle 110 is fluidically connected to internal volume 70 of container 62 via flexible conduit 90 and fluid flow control valve 100 whereby fluid contained in container 62 is controllably released from the drip nozzle during operation of system 60.

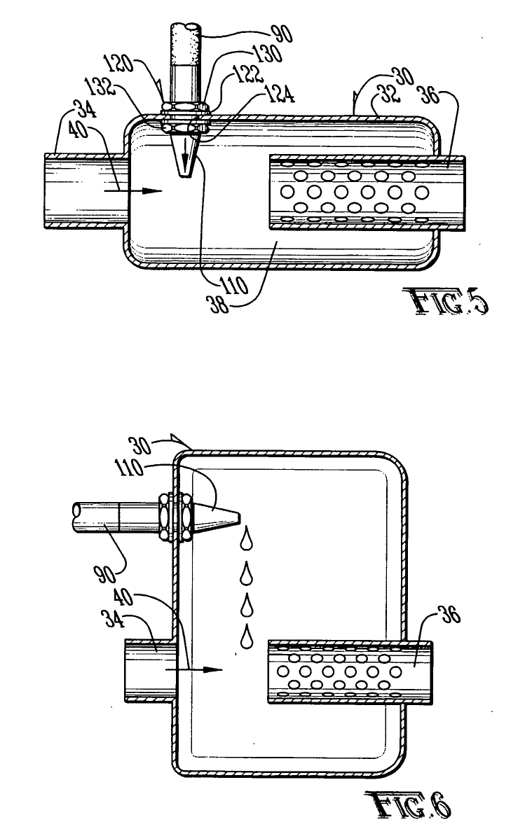

A drip nozzle mounting unit 120 mounts drip nozzle 110 on the muffler. Mounting unit 120 includes a mounting bracket 122 and a mounting hole 124 defined through the housing of the muffler. Drip nozzle 110 extends through the mounting hole into internal area 38 of the muffler to be in fluid contact with exhaust gases flowing through the muffler from the internal combustion engine when the lawnmower is in use. The drip nozzle is located to be fluidically connected to the internal volume of the muffler so fluid from the container will drip directly into the exhaust gases to be vaporized thereby during the flowing of the gases. The fluid from the container, such as the pesticide, chemical, or insecticide, may be introduced to exhaust gas at about 90° or generally perpendicular to the flow direction of the exhaust gas from the engine. Introducing the fluid at about 90° may improve the mixing, vaporizing and dispersing of the fluid into the exhaust gas. In this regard, the drip nozzle 110 may be coupled to the muffler 30 so that the drip nozzle 110 is about 90° to the flow direction of the exhaust gas from the engine, as shown in FIG. 5. Alternatively, the drip nozzle 110 may be coupled to the muffler 30 so that the longitudinal axis of the drip nozzle 110 is substantially parallel with the direction 40 of the exhaust gases so that the fluid from the drip nozzle 110 is introduce to the exhaust gas at about 90° to the direction 40 of the exhaust gases.

A first nut 130 is located on the outside of the housing of the muffler adjacent to the mounting hole, and a second nut 132 is located on the inside of the housing of the muffler adjacent to the mounting hole. Drip nozzle 110 is mounted on the housing of the muffler by the first and second nuts. Welding can be used in place of the nuts if desired.

Operation of the fogging system includes filling the container with the desired liquid chemical, hanging the container on the crossbar, starting the internal combustion engine, allowing the engine and the muffler to warm up, opening the flow control valve to allow liquid chemical to flow through the flexible conduit and out of the drip nozzle to be mixed with hot exhaust gases flowing from the internal combustion engine through the muffler. The chemical is vaporized and mixed with the gases and flows therewith out of the muffler into the area surrounding the lawnmower during operation of the lawnmower. The direct contact between the chemical and the hot exhaust gases makes mixing, vaporizing and dispersing of the chemical efficient while the location of the container on the handle crossbar makes it easy to fill, remove and service the container. It is also noted that the fogging system 10 can be used on a riding lawnmower as well, provided the muffler is located a safe distance from the operator. The dispersing of the fog can be at any convenient height, such as one foot or the like, so the mist generated will rapidly settle on the ground or grass to kill insects and the like. System 10 can be installed by the factory or as a retrofit due to its simplicity.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. An insecticide fogging system comprising:
A) a lawnmower having:
(1) a housing which has a first surface that is a top surface when the lawnmower is in use and a second surface that is a bottom surface when the lawnmower is in use;
(2) wheels on the bottom surface of the housing;
(3) an internal combustion engine mounted on the top surface of the housing, the internal combustion engine being operatively connected to the wheels to drive the wheels and propel the lawnmower when the lawnmower is in use, the internal combustion engine including a muffler that is fluidically connected thereto to receive hot exhaust gases being generated by the internal combustion engine during operation and to direct those hot exhaust gases out of the internal combustion engine into the area surrounding the lawnmower when the lawnmower is in operation, the muffler including:
(a) a housing;
(b) an inlet end;
(c) an outlet end; and
(d) an internal area in which exhaust gases from the internal combustion engine are located as the gases flow from the internal combustion engine into the area surrounding the lawnmower during operation of the internal combustion engine;
(4) a handle which is contacted by a user when the lawnmower is in use; and
(5) a crossbar on the handle;
B) a chemical dispersing system which includes:
(1) a container which includes:
(i) a first end which is a top end when the container is in use;
(ii) a second end which is a bottom end when the container is in use;
(iii) a wall connecting the first end of the container to the second end of the container;
(iv) an internal volume defined by the second end of the container and the wall; and
(v) a fluid outlet port defined in the second end of the container;
(2) a J-shaped hanger having a first end fixedly mounted on the wall of the container adjacent to the top end of the container and a second end,.the hanger being arcuate adjacent to the second end thereof and being mounted on the crossbar of the lawnmower by the arcuate portion thereof when the container is in use;
(3) a flexible conduit having an inlet end mounted on the second end of the container adjacent to the fluid outlet port and fluidically connected to the internal volume of the container via the fluid outlet port, the flexible conduit having an outlet end;
(4) a fluid flow control valve mounted on the flexible conduit closely adjacent to the inlet end of the flexible conduit and connected thereto to control the flow of fluid in the flexible conduit; and
(5) a drip nozzle on the outlet end of the flexible conduit, the drip nozzle being fluidically connected to the internal volume of the container via the flexible conduit and the fluid flow control valve; and
C) a drip nozzle mounting unit which mounts the drip nozzle on the muffler and which includes:
(1) a mounting bracket;
(2) a mounting hole defined through the housing of the muffler, the drip nozzle extending through the mounting hole into the internal area of the muffler to be in fluid contact with exhaust gases flowing through the muffler from the internal combustion engine when the lawnmower is in use;
(3) a first nut that is located on the outside of the housing of the muffler adjacent to the mounting hole;
(4) a second nut that is located on the inside of the housing of the muffler adjacent to the mounting hole; and
(5) the drip nozzle being mounted on the housing of the muffler by the first and second nuts.

2. An insecticide fogging system comprising:
A) a lawnmower having:
(1) an internal combustion engine and a muffler, with the muffler having a housing having an internal area in which exhaust gases from the internal combustion engine are located as the gases flow from the internal combustion engine into the area surrounding the lawnmower during operation of the internal combustion engine;
(2) a handle which is contacted by a user when the lawnmower is in use; and
(3) a crossbar on the handle;
B) a chemical dispersing system which includes:
(1) container having an internal volume and a fluid outlet port;
(2) a hanger fixed to the container and releasably mounted on the crossbar of the lawnmower to releasably mount the container on the lawnmower when the container is in use;
(3) a flexible conduit having an inlet end fluidically connected to the internal volume of the container via fluid outlet port, the flexible conduit having an outlet end;
(4) a fluid flow control valve mounted on the flexible conduit closely adjacent to the inlet end of the flexible conduit and connected thereto to control the flow of fluid in the flexible conduit; and
(5) a drip nozzle on the outlet end of the flexible conduit, the drip nozzle being fluidically connected to the internal volume of the container via the flexible conduit and the fluid flow control valve; and
C) a drip nozzle mounting unit which mounts the drip nozzle on the muffler and which includes a mounting hole defined through the housing of the muffler, the drip nozzle extending through the mounting hole into the internal area of the muffler to be in fluid contact with exhaust gases flowing through the muffler from the internal combustion engine when the lawnmower is in use.

3. An insecticide fogging system comprising:
a lawnmower having an internal combustion engine and a muffler, the muffler having a housing with an internal area in which exhaust gases from the internal combustion engine are located as the exhaust gases flow from the internal combustion engine into the area surrounding the lawnmower during operation of the internal combustion engine;
a container having an internal volume and a fluid outlet port;
a flexible conduit having an inlet end fluidically connected to the internal volume of the container via the fluid outlet port, the flexible conduit having an inlet end and an outlet end; and a drip nozzle on the outlet end of the flexible conduit, the drip nozzle being fluidically connected to the internal volume of the container via the flexible conduit, the drip nozzle extending through the internal area of the muffler such that the drip nozzle provides the fluid from the container at about 90° along a general direction of flow of the exhaust gases through the internal area of the muffler.

4. The insecticide fogging system according to claim 3, where the drip nozzle has a longitudinal axis, and the drip nozzle is coupled to the muffler such that the longitudinal axis of the drip nozzle is about 90° to the general flow direction of the exhaust gases.

5. The insecticide fogging system according to claim 3, where the drip nozzle has a longitudinal axis and the drip nozzle is coupled to the muffler such that the longitudinal axis of the drip nozzle is substantially parallel with the general flow direction of the exhaust gases.

6. The insecticide fogging system according to claim 3, further including:
a handle coupled to the lawnmower, where the handle is contacted by a user when the lawnmower is in use, and
a crossbar on the handle; and
a hanger coupled to the container and releasably mounted on the crossbar of the lawnmower to releasably mount the container on the lawnmower when the container is in use.

7. The insecticide fogging system according to claim 3, further including:
a fluid flow control valve mounted on the flexible conduit closely adjacent to the inlet end of the flexible conduit and connected thereto to control the flow of fluid in the flexible conduit.
